(19) United States
(12) Patent Application Publication
(10) Pub. No.: US 2017/0118958 A1
(43) Pub. Date: May 4, 2017

(54) PET CHEWING TOY

(71) Applicant: TONGFU MANUFACTURING CO., LTD., Nanjing (CN)

(72) Inventors: Yaomin MA, Nanjing (CN); Wen ZHANG, Nanjing (CN)

(73) Assignee: TONGFU MANUFACTURING CO., LTD., Nanjing (CN)

(21) Appl. No.: 15/146,446

(22) Filed: May 4, 2016

(30) Foreign Application Priority Data
Oct. 30, 2015 (CN) 201520852306.X

(51) Int. Cl. A01K 15/02; A01K 5/00

(52) U.S. Cl. CPC A01K 15/025; A01K 5/00

(57) ABSTRACT

A pet chewing toy, including a shell and treats; a containing cavity is arranged in shell, treats and fixing plug are arranged in containing cavity, a leaking feeding and plug hole are arranged at two ends of containing cavity respectively, a part of the treats is fixed in containing cavity, and other part of the treats is exposed out of leaking feeding hole, and fixing plug seals plug hole and abuts against the treats. Pet chewing toy is simple in structure and convenient and fast for treats detaching and arranging, treats are arranged from the inside of the shell of toy, operation is laborsaving, and individuals can easily detach and arrange the treats; toy has chewing function and belongs to edible toy capable of cleaning tartar and dental plaque; and pet obtains certain pleasure in process of obtaining treats, and the pet is enabled to consume time and divert loneliness.

### TECHNICAL FIELD

The present utility model belongs to a pet toy, and particularly relates to a pet chewing toy.

### BACKGROUND

A pet toy is mainly used for a pet to play, so as to reduce a chance that the pet damages articles at home. However, an existing pet toy is single in function, and has certain defects, for example, in a process that the pet grows teeth, the pet bites the articles for chewing, but the existing pet toy does not have a chewing function; and in addition, the pet toy in the market difficultly attracts attention of the pet to play for a long time, and the pet easily loses an interest of playing the pet toy.

Although a pet leaking feeder attracting the pet to play and eat appears in the market, and the pet consumes time and acquires a pleasure in a process of obtaining treats, the existing pet leaking feeder and treats are arranged in an interference or excessive match generally, and in the mounting process, the treats are required to be pushed into a leaking feeding hole with a steplike inner wall, the female or children place the treats with great effort and operation is very inconvenient.

### SUMMARY

The present utility model aims to overcome defects of the prior art and provides a pet chewing toy, the pet chewing toy is compact and hard in texture, a pet needs to apply a certain biting force in a biting process, and the toy is an edible toy capable of cleaning tartar and dental plaque; meanwhile, in a process of the obtaining treats, the pet needs to overcome certain difficulty, thus enabling the pet to consume time and divert loneliness; and in addition, the pet toy is convenient for detaching and treats placing, and can be easily operated by even the female or children.

Therefore, the present utility model provides a pet chewing toy, comprising a shell and treats; a containing cavity is arranged in the shell, the treats and a fixing plug are arranged in the containing cavity, a leaking feeding hole and a plug hole are arranged at two ends of the containing cavity respectively, a part of the treats is fixed in the containing cavity, the other part of the treats is exposed out of the leaking feeding hole, and the fixing plug seals the plug hole and abuts against the treats.

The treats are enabled to penetrate through the plug hole and is arranged to the leaking feeding hole from the plug hole, a part of the treats is fixed in the containing cavity, the other part of the treats is exposed out of the leaking feeding hole, then the fixing plug seals the plug hole and abuts against the treats, thus preventing the treats from being loosened from the containing cavity. The toy is fast, convenient and laborsaving in detaching and mounting and is suitable for the female and children.

As a structural improvement, the treats are steplike, a circle of inward bulge is formed at the inner wall of the containing cavity close to the leaking feeding hole, and the bulge is clamped at a step of the treats. Since the treats are steplike, the treats are clamped in the containing cavity by the bulge of the containing cavity at the leaking feeding hole, thus preventing the treats from falling out from the leaking feeding hole.

As a structural improvement, a clamping block is arranged at each of two ends of the fixing plug, a circle of groove corresponding to the clamping block is formed at the inner wall of the containing cavity close to the plug hole, and the clamping blocks are clamped in the groove. By clamping the fixing blocks in the groove, the fixing plug seals the plug hole.

As a structural improvement, a buckle is arranged at the bottom of each clamping block, and two clamping grooves corresponding to the buckles are arranged in the groove. The fixing plug is rotated to enable the buckles on the clamping blocks to be clamped in the clamping grooves, thus further enhancing mounting tightness of the fixing plug and reducing a probability that the fixing plug is accidentally detached by a dog.

Further, as a structural improvement, the bottom of the fixing plug is provided with a strip fixing lug. When the fixing plug is detached or mounted, the strip fixing lug is held by hand to facilitate force applying, and the operation is convenient, fast and laborsaving.

Further more, the shell can have various shapes, and the shell provided by the present utility model is frog-shaped.

The present utility model has the beneficial effects that the pet chewing toy provided by the present utility model is simple in structure and convenient and fast for treats detaching and arranging, the treats are arranged from the inside of the shell of the toy, operation is laborsaving, and the female and children can easily detach and arrange the treats; the toy has a chewing function and belongs to an edible toy capable of cleaning tartar and dental plaque; and the pet obtains a certain pleasure in a process of obtaining the treats, and the pet is enabled to consume time and divert loneliness.

### BRIEF DESCRIPTION OF THE DRAWINGS

FIG. 1 is an explosion structural schematic diagram of a pet chewing toy provided according to the present embodiment.

FIG. 2 is a sectional view of the pet chewing toy provided according to the present embodiment.

FIG. 3 is an integral structural schematic diagram of the pet chewing toy provided according to the present embodiment.

FIG. 4-FIG. 7 are schematic diagrams of an assembly process of the pet chewing toy provided according to the present embodiment.

Marks description of the drawings: 1, shell, 2, treats, 3, containing cavity, 3.1, leaking feeding hole, 3.2, bulge, 3.3, plug hole, 3.4, clamping groove, 3.5, groove, 4, fixing plug, 4.1, clamping block, 4.2, buckle, 4.3, strip fixing lug

### DETAILED DESCRIPTION

The present utility model is further described in combination with drawings and a specific embodiment.

### Embodiment

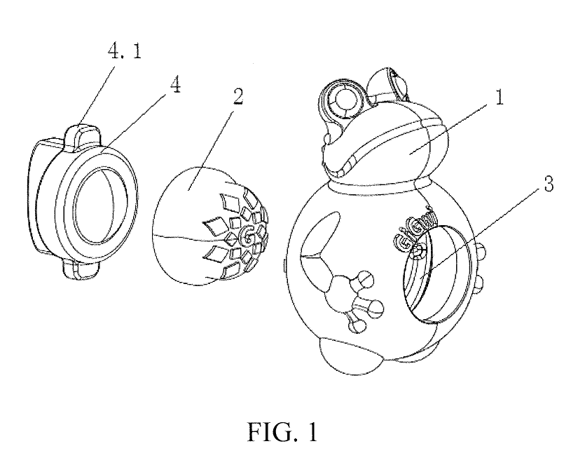

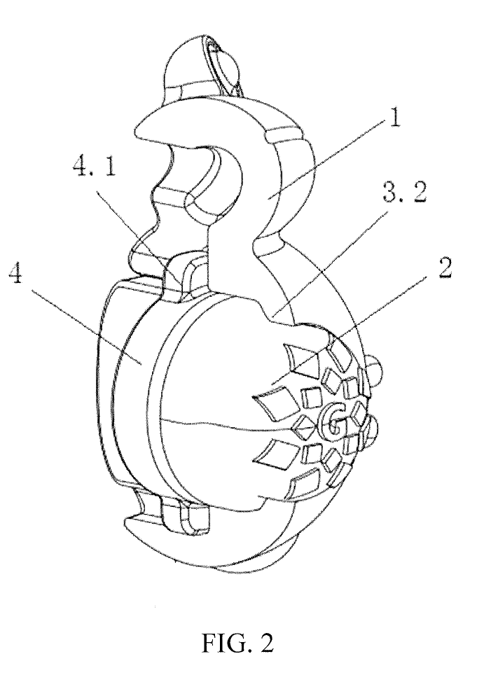

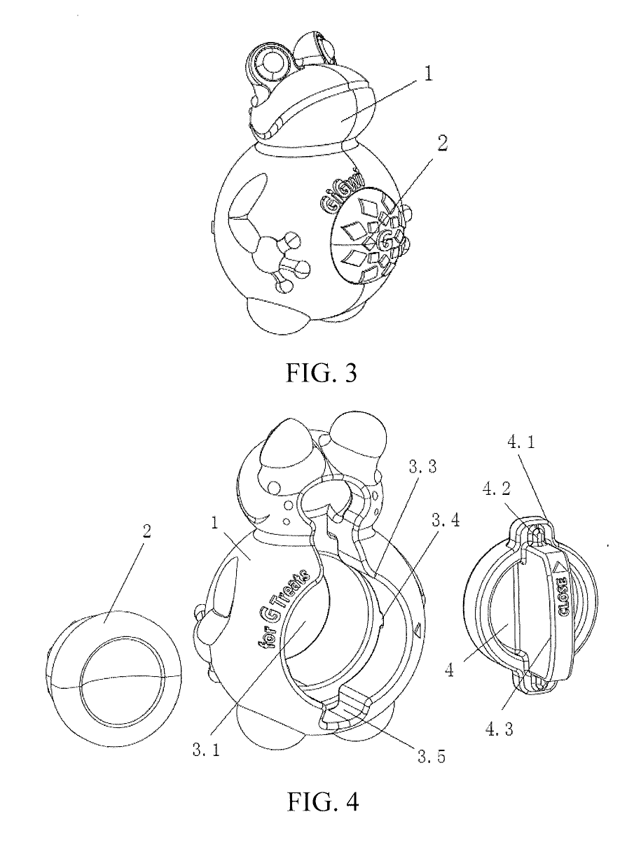

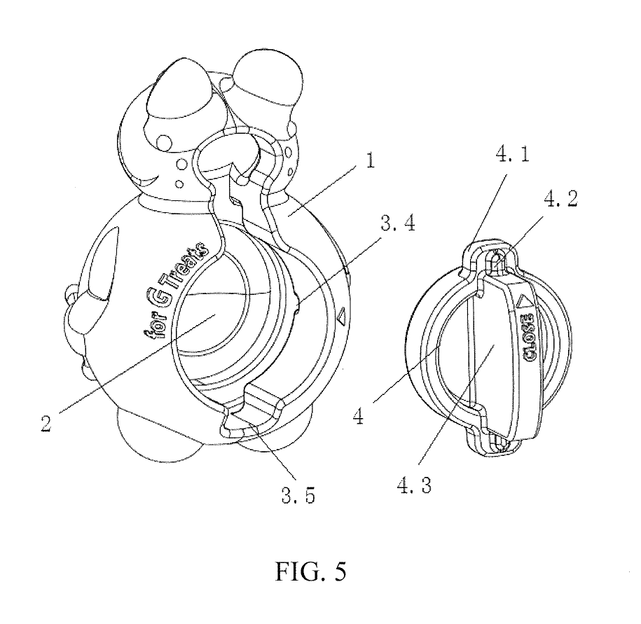

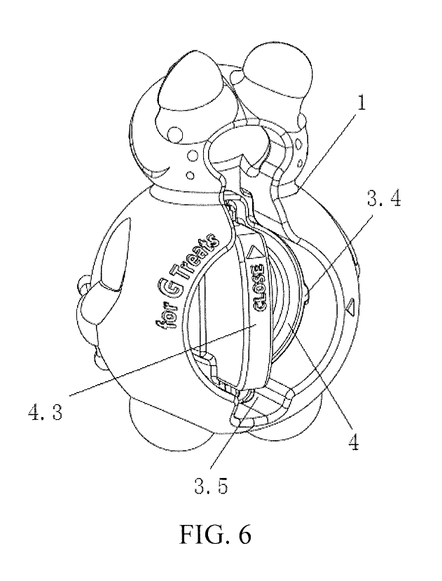

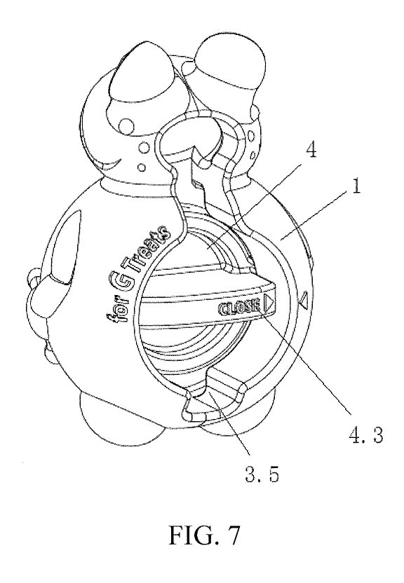

The present embodiment provides a pet chewing toy, as shown in FIG. 1, FIG. 2 and FIG. 3, the present embodiment provides a frog-shaped pet chewing toy, comprising a shell 1 and treats 2; a containing cavity 3 is arranged in the shell 1, the treats 2 and a fixing plug 4 are arranged in the containing cavity 3, a leaking feeding hole 3.1 and a plug hole 3.3 are arranged at two ends of the containing cavity 3 respectively, a part of the treats 2 is fixed in the containing cavity 3, the other part of the treats is exposed out of the leaking feeding hole 3.1, and the fixing plug 4 seals the plug hole 3.3 and abuts against the treats 2. As shown in FIG. 4, FIG. 5, FIG. 6 and FIG. 7, the treats 2 are steplike, a circle of inward bulge 3.2 is formed at the inner wall of the containing cavity 3 close to the leaking feeding hole 3.1, and the bulge 3.2 is clamped at a step of the treats 2. Since the treats 2 are steplike, the treats 2 are clamped in the containing cavity 3 by the bulge 3.2 of the containing cavity 3 at the leaking feeding hole 3.1, thus preventing the treats 2 from falling out from the leaking feeding hole 3.1.

In order to seal the fixing plug 4 at the plug hole 3.3, a clamping block 4.1 is arranged at each of two ends of the fixing plug 4, a circle of groove 3.5 corresponding to the clamping block 4.1 is formed at the inner wall of the containing cavity 3 close to the plug hole 3.3, and the clamping blocks 4.1 are clamped in the groove 3.5. By clamping the fixing blocks 4.1 in the groove 3.5, the fixing plug 4 seals the plug hole 3.3.

Further, a buckle 4.2 is arranged at the bottom of each clamping block 4.1, and two clamping grooves 3.4 corresponding to the buckles 4.2 are arranged in the groove 3.5. The fixing plug 4 is rotated to enable the buckles 4.2 on the clamping blocks 4.1 to be clamped in the clamping grooves 3.4, thus further enhancing mounting tightness of the fixing plug 4 and reducing a probability that the fixing plug 4 is accidentally detached by a dog. For a purpose of more laborsaving operation, the bottom of the fixing plug 4 is provided with a strip fixing lug 4.3. When the fixing plug 4 is detached or mounted, the strip fixing lug 4.3 is held by hand to facilitate force applying, and the operation is convenient, fast and laborsaving.

A process of assembling the pet chewing toy is described in combination with FIG. 4, FIG. 5, FIG. 6, and FIG. 7, when the treats 2 are mounted, the treats 2 are enabled to penetrate through the plug hole 3.3 at the back of the frog-shaped chewing toy, a part of the treats is fixed in the containing cavity 3 from bottom to top, the other part of the treats is exposed out of the leaking feeding hole 3.1, the bulge 3.2 in the containing cavity 3 close to the leaking feeding hole 3.1 is clamped at the step of the treats 2, and the treats 2 are prevented from falling out from the leaking feeding hole 3.1; the fixing plug 4 is plugged into the plug hole 3.3, the clamping blocks 4.1 are clamped in the groove 3.5, the strip fixing lug is held by hand, the fixing plug 4 is rotated to clamp the buckles 4.2 at the bottom of the clamping blocks 4.1 into the clamping grooves 3.4, thus fixing the fixing plug 4 and reducing a probability of detaching. The pet chewing toy is simple in structure and convenient and fast for treats detaching and arranging, the treats are arranged from the inside of the shell of the toy, operation is laborsaving, and the female and children can easily detach and arrange the treats.

The mounted frog-shaped chewing toy is thrown to a pet for playing, since the chewing toy is compact and hard in texture, a pet needs to apply a certain biting force in a biting process to achieve the chewing aim, and the toy is capable of cleaning tartar and dental plaque; and in a process of playing the toy, the pet attempts to obtain the treats exposed out of the leaking feeding hole, however, the pet needs to overcome certain difficulty if wanting obtain the treats, so that the pet obtains certain pleasure in a use process, and the pet is enabled to consume time and divert loneliness.

The above is merely examples of the present utility model and not limitative to the present utility mode, and all designs same or similar to the present utility model falls within a protective scope of the present utility mode.

1. A pet chewing toy, comprising a shell and treats, wherein a containing cavity is arranged in the shell the treats and a fixing plug are arranged in the containing cavity, a leaking feeding hole and a plug hole are arranged at two ends of the containing cavity respectively, a part of the treats is fixed in the containing cavity, and the other part of the treats is exposed out of the leaking feeding hole; and the fixing plug seals the plug hole and abuts against the treats.

2. The pet chewing toy according to claim 1, wherein the treats are steplike, a circle of inward bulge is formed at the inner wall of the containing cavity close to the leaking feeding hole, and the bulge is clamped at a step of the treats.

3. The pet chewing toy according to claim 2, wherein a clamping block is arranged at each of two ends of the fixing plug, a circle groove corresponding to the clamping block is formed at the inner wall of the containing cavity close to the plug hole, and the clamping blocks are clamped in the groove.

4. The pet chewing toy according to claim 3, wherein a buckle is arranged at the bottom of each clamping block and two clamping grooves correspond to the buckles are arranged in the groove.

5. The pet chewing toy according to claim 1, wherein the bottom of the fixing plug is provided with a strip fixing lug.
